(19) United States
(12) Patent Application Publication
(10) Pub. No.: US 2010/0163548 A1
(43) Pub. Date: Jul. 1, 2010

(54) APPARATUS AND METHOD FOR INDUCTIVELY APPLYING HEAT TO FOOD

(75) Inventor: Charles D. Cretors, Lake Forest, IL (US)

Correspondence Address: PERKINS COIE LLP;PATENT-SEA, P.O. BOX 1247, SEATTLE, WA, 98111-1247, US

(73) Assignee: C. Cretors & Company, Chicago, IL (US)

(21) Appl. No.: 12/640,314

(22) Filed: Dec. 17, 2009

Related U.S. Application Data
(60) Provisional application No. 61/141,943, filed on Dec. 31, 2008.

(51) Int. Cl. H05B 6/12

(52) U.S. Cl. 219/620

(57) ABSTRACT

Inductive food heating devices and methods of cooking food with inductive heating devices are disclosed herein. An embodiment of an inductive food heating device configured in accordance with the present disclosure includes a base structure, a food rotating system, an inductive food heating system, and a plurality of rollers. The inductive food heating system includes an electromagnet that can generate a magnetic field. The rollers include a magnetic material that generates heat when positioned in the magnetic field. The food rotating system turns the rollers, and thus food supported on the rollers is turned and cooked by the inductively heated rollers.

### CROSS-REFERENCE TO RELATED APPLICATION(S)

This patent application claims the benefit under 35 U.S.C. §119 of U.S. Provisional Patent Application No. 61/141,943, filed on Dec. 31, 2008, entitled “Inductively Heated Hot Dog Cookers.” That application is incorporated herein in its entirety by reference.

### TECHNICAL FIELD

The present disclosure relates generally to devices for heating and/or cooking food. In particular, the present disclosure relates to devices for heating and/or cooking food, e.g., hot dogs, sausages, etc., that rotate the food.

### BACKGROUND

“Cooking” generally refers to the application of heat to food. Conventional cooking devices for heating food include ovens, cooktops, griddles, etc. Conventional methods of generating heat for cooking can include supplying electrical current to a resistance element or a halogen-filled bulb.

In the case of cooking hot dogs, it is conventional to use tubular rollers that support the hot dogs. Electric heating elements positioned inside the rollers heat the rollers, and a drive mechanism coupled to the rollers turns the rollers. The hot dogs are rotated and heated due to contact with the rollers. The electric heating elements are fixed and do not rotate with the rollers. Accordingly, one downside of conventional hot dog heating devices is configuring the drive system for turning the rollers and not the heating elements that extend generally along the axis of roller rotation. Another downside is that the drive system must be configured to withstand the heat from the heating elements.

### BRIEF DESCRIPTION OF THE DRAWINGS

FIG. 1 is an isometric view, with a partial cut-away, of a food heater according to an embodiment of the present disclosure.

FIG. 2 is an isometric detail view showing a food rotating system of the food heater of FIG. 1.

FIG. 3A is a partial schematic view showing an embodiment of a food heating system of the food heater of FIG. 1.

FIG. 3B is a schematic view illustrating another embodiment of a food heating system of the food heater of FIG. 1.

FIG. 4A is a schematic diagram showing an embodiment of a food heating system driver circuit.

FIG. 4B is a schematic diagram showing another embodiment of a food heating system driver circuit.

FIG. 5 is an isometric view showing rollers of the food heater of FIG. 1.

FIG. 6 is a schematic illustration of a system for cooking a hot dog with the food heater of FIG. 1.

### DETAILED DESCRIPTION

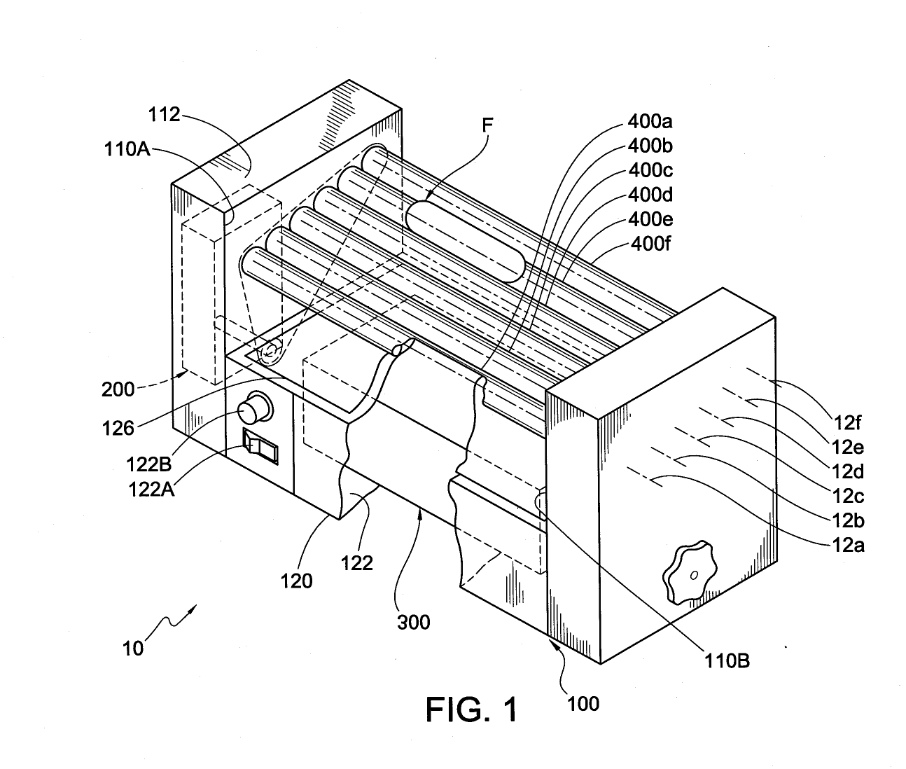

The following disclosure describes several embodiments of food heating and/or cooking devices. Food products that can be heated according to the present disclosure can include, for example, hot dogs, sausage links, bratwurst, other forms of encased meat, or any kind of food that can be prepared by movement on or by a conveyance, such as rotation with one or more heated rollers. Specific details of several embodiments of the present disclosure are described below with reference to FIGS. 1 to 6 to provide a thorough understanding of the embodiments. Other details describing well-known structures and systems often associated with heating or cooking food, however, are not set forth below to avoid unnecessarily obscuring the description of the various embodiments. Accordingly, those of ordinary skill in the art will understand that the invention may have other embodiments in addition to those described below. Such embodiments may include other elements and features in addition to those described below, or they may lack one or more of the features or elements described below.

FIG. 1 is an isometric view of a food heater 10 configured in accordance with an embodiment of the disclosure. The food heater 10 includes a base structure 100, a food moving system 200 (shown schematically), an inductive food heating system 300 (shown schematically), and a plurality of rollers 400. The rollers 400 (identified individually as rollers 400a to 400f) extend along parallel, spaced axes 12 (identified individually as axes 12a to 12f). There are six axes in the embodiment shown in FIG. 1; however, other embodiments according to the present disclosure can include two or more axes.

The base structure 100 includes walls 110 (a first sidewall 110A and a second sidewall 110B are shown in FIG. 1) supporting the rollers 400. The spacing between the walls 110 can be selected so as to correspond to the number and size of a food product F (e.g., a hot dog, sausage link, etc.) that is to be heated. For example, three six-inch long hot dogs can be placed end-to-end between walls that are spaced approximately 20 inches from one another. Any suitable wall spacing can be selected in accordance with the number and size of products to be heated. In other embodiments, one or more intermediate walls (not shown) may be disposed between the first and second sidewalls 110A and 110B to provide support for different sets of the rollers 400.

In the embodiment shown in FIG. 1, individual walls 110 include a corresponding interior volume 112 that can house, for example, at least a portion of the moving system 200, etc. Accordingly, the wall 110 can enclose the moving system 200 and thereby separate the moving system 200 from the rollers 400, which can reduce, for example, drippings off the rollers 400 contacting the moving system 200, lubricants off the rotating system contacting the rollers 400, etc. In other embodiments, other components of the food heater 10 can additionally or alternatively be positioned in the interior volume 112 such that the wall 110 can provide a barrier that limits exposure between the food product F being heated on the rollers 400 and one or more operating components of the food heater 10. In still other embodiments, the walls 110 can have any suitable arrangement, e.g., a plate, which supports the rollers 400.

The base structure 100 can also include enclosures, spacers, webs, beams, panels, or any suitable structure that extends between and establishes the relative position of the walls 110. In the embodiment of the present disclosure shown in FIG. 1, an enclosure 120 adjoins lower portions of the walls 110. The enclosure 120 can include a corresponding interior volume 122 that can house, for example, at least a portion of the heating system 300, etc. Accordingly, the enclosure 120 can separate the heating system 300 from the rollers 400, which can, for example, reduce drippings off the rollers 400 contacting the heating system 300. In other embodiments, other components of the food heater 10 can additionally or alternatively be positioned in the interior volume 122 such that the enclosure 120 can provide a barrier that limits exposure between the food product F being heated on the rollers 400 and one or more operating components of the food heater 10.

As shown in FIG. 1, operator or user controls 124 can be mounted on the enclosure 120. The controls 124 can include, for example, a first control 124A for the moving system 200 and a second control 124B for the heating system 300. According to other embodiments of the present disclosure, the controls 124 can be mounted on the walls 110 or elsewhere on the base structure 100.

The base structure 100 can also include a removable tray 126 positioned over the enclosure 120 and between the walls 110. Typically, the tray 126 is positioned beneath the food product F, e.g., a hot dog, so as to collect drippings from the food product F. In the embodiment shown in FIG. 1, the tray 126, which can include a ceramic material or another non-magnetic and/or dielectric material(s), is removable for ease of cleaning relative to the enclosure 120. In other embodiments, the tray 126 can be fixed.

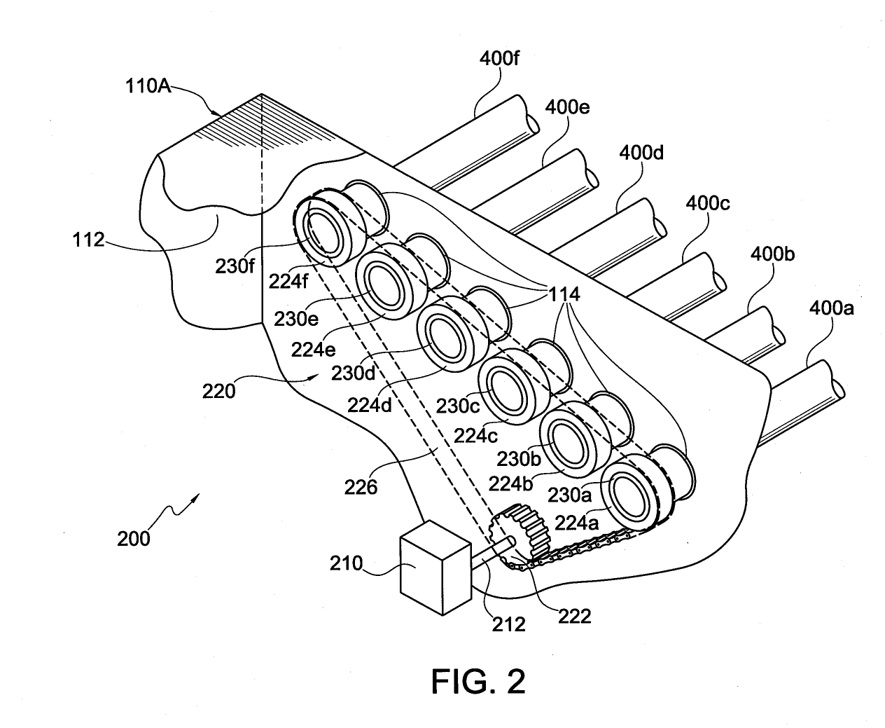

FIG. 2 is an enlarged view illustrating certain details of the food moving system 200 configured in accordance with an embodiment of the present disclosure. The food moving system 200 can include approximately parallel rollers (as illustrated) but can also be configured in other arrangements, e.g., carousels, etc. The embodiment of the moving system 200 shown in FIG. 2 can include an actuator 210 and a drive arrangement 220. The actuator 210 (shown schematically in FIG. 2) is typically an electric gear motor, but can be any suitable motive device that causes the rollers 400 to rotate at a desired speed. In the illustrated embodiment, the drive arrangement 220 includes a drive sprocket 222, a plurality of driven sprockets 224 (identified individually as driven sprockets 224a to 224f), and a drive chain 226 (e.g., a metal roller chain). The drive sprocket 222, driven sprockets 224 and drive chain 226 are shown partially schematically in FIG. 2 (only a portion of the chain links and sprocket teeth are shown in FIG. 2 for purposes of illustration). The drive sprocket 222 is operably coupled to the actuator 210, e.g., fixed to an output shaft 212. The individual driven sprockets 224 are operably coupled to a corresponding roller 400 and can be supported by a bearing 114 for relative rotation with respect to the sidewall 110A. The drive chain 226 operably couples the drive sprocket 222 to the driven sprockets 224. A plurality of connectors 230 (individual connectors 230a to 230f are shown in FIG. 2) couple individual driven sprockets 224 to corresponding rollers 400. In other embodiments of the present disclosure, the drive arrangement 220 can include pulleys and a belt, a gear train, or other drive systems that are suitable for conveying rotation from the actuator 210 to the rollers 400.

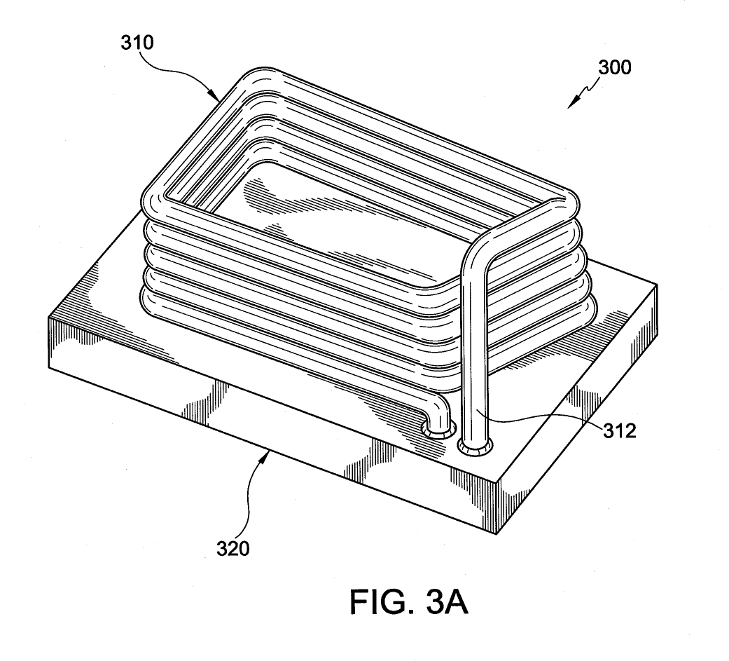

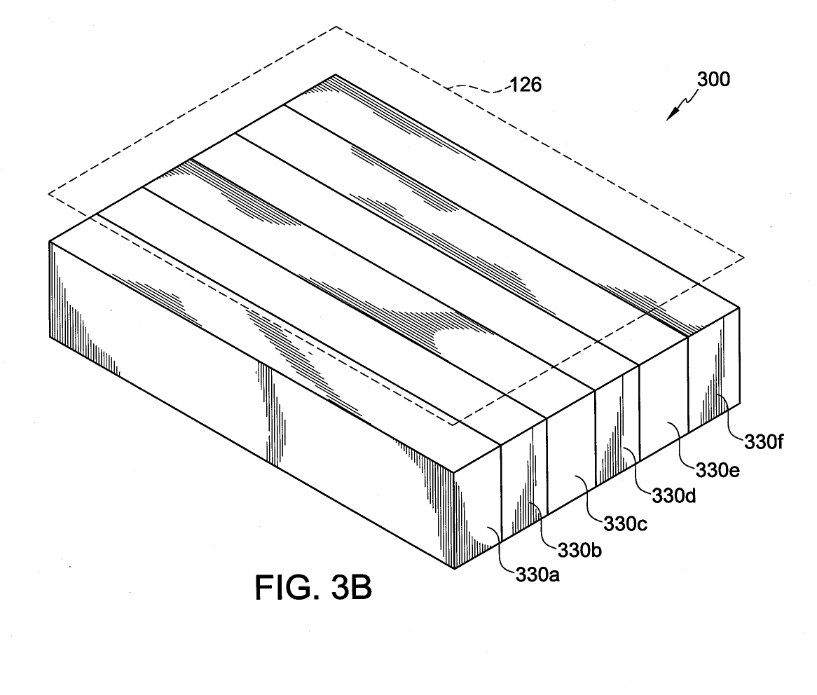

FIG. 3A shows details of the food heating system 300 according to one embodiment of the present disclosure. The food heating system 300 can include an induction heating element 310 and an electronic driver 320. As shown in FIG. 3, the element 310 can be configured as a high-frequency electromagnet electrically coupled to the electronic driver 320, which can be controlled with the second control 124B (FIG. 1).

The element 310 includes an electrical conductor 312, e.g., a wire, arranged in a coiled configuration. In one embodiment according to the present disclosure, the conductor 312 can be configured as a stranded conductor with individual varnish-insulated wires. The gauge of the conductor 312, the size and shape of the coil, the number of turns in the coil, etc. can affect the size, shape and strength of the magnetic field that is generated by the element 310 in response to an electrical current from the driver 320. One example of an embodiment in accordance with the present disclosure can include a pancake litz coil constructed from 26 strands of 0.4 mm litz wire. The coil includes 35 turns with an inner diameter of approximately 40 mm and an outer diameter of approximately 185 mm. The coil can carry approximately 25 amperes. The driver 320 can supply a high-frequency current having a frequency range from approximately 10 kilohertz (kHz) to approximately 500 kHz and particularly in the range of approximately 15 kHz to approximately 150 kHz. The voltage range of the current supplied to the element 310 by the driver 320 can be up to 800 volts or greater, e.g., about approximately 100 volts to approximately 400 volts.

Not wishing to be bound by theory, in one embodiment, a magnetic material, for example, a cast-iron skillet, is placed in the magnetic field that the element 310 generates, the magnetic field transfers or induces energy into the skillet. The induced energy causes the skillet to become hot. Specifically, the magnetic field generates a loop current (also known as an eddy current) within the magnetic metal of the cooking vessel. Electrical resistance of the magnetic material to the loop current generates heat in much the same way that heat is generated by a current flow through an electrical heating element of a conventional cooking device. The difference, however, is that the element 310 generates heat in the magnetic metal of the cooking vessel, and heating of other portions of the food heater 10 can be reduced or eliminated. By controlling the strength of the electromagnetic field, the amount of heat generated by the magnetic material can be controlled. Moreover, the amount of heat that is generated can be varied almost instantaneously by controlling the strength of the electromagnetic field.

FIG. 3B shows details of the food heating system 300 according to a second embodiment of the present disclosure. The food heating system 300 can include a plurality of induction-cooker elements 330 (identified individually as elements 330a to 330f). The relative arrangement and shape(s) of the elements 330 can be used to assemble a magnetic field that can uniformly generate heat in one portion, several portions, or across an entire cooking field, e.g., as defined by the tray 126 (FIG. 1). In other embodiments according to the present disclosure, the plurality of elements 330 can be used to assemble a magnetic field specifically for non-uniform heat generation. For example, it may be desirable to cook one food product at one temperature or heat level and, at a different portion of the same food heater, cook another food product at another temperature or heat level.

In some embodiments according to the present disclosure, the cooking power of the heating system 300 can range from less than about 1,000 Watts (W) to about 5,000 W or more. In these embodiments, the heating systems disclosed herein can have energy efficiencies, e.g., in terms of the cooking heat that is delivered to a food product, that are approximately 50 percent greater than conventional electrical resistance food heaters and approximately twice as efficient as fuel gas heaters.

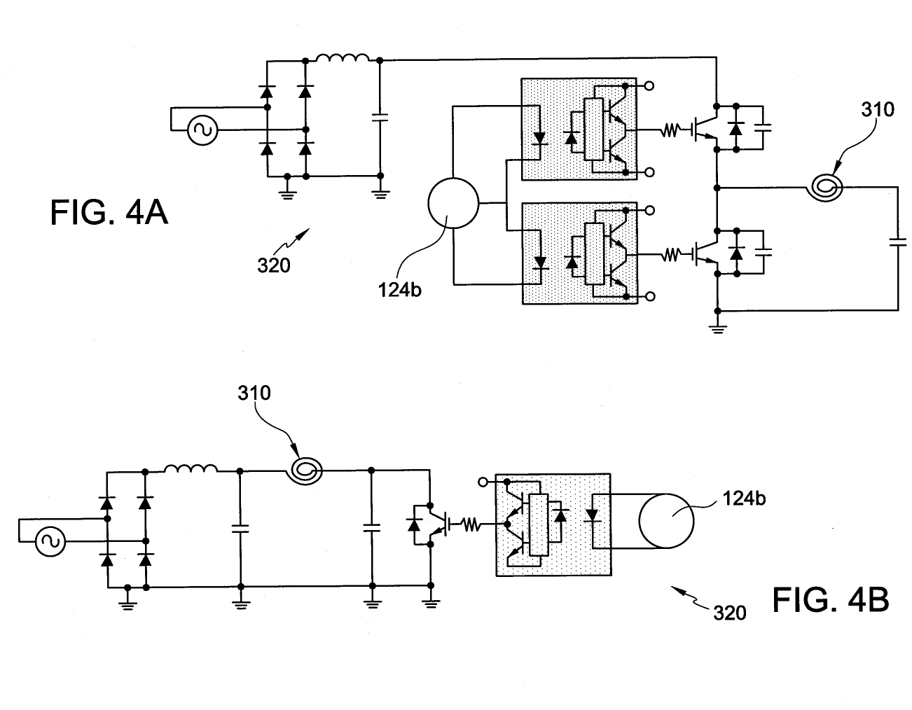

FIGS. 4A and 4B are schematic illustrations of drivers 320 that can be implemented in embodiments according to the present disclosure. FIG. 4A shows a half-bridge series resonant converter circuit 320A and FIG. 4B shows a quasi-resonant converter circuit 320B. Insofar as the circuits 320A and 320B are typical and well understood by one of ordinary skill in the art, no further discussion of the drivers 320 is included or required for an understanding of embodiments according to the present disclosure. Embodiments in accordance with the present disclosure can use other suitable circuits for driving the elements 310 and/or 330.

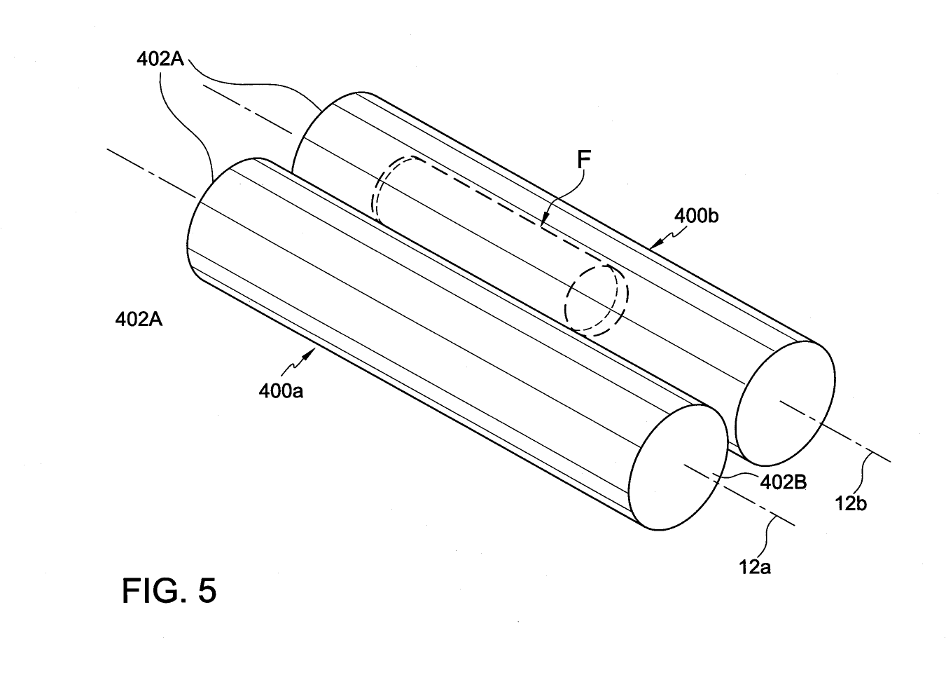

FIG. 5 shows rollers 400 (two of which are identified individually as rollers 400a and 400b) configured in accordance with an embodiment of the present disclosure. The rollers 400 support the food product F, e.g., a hot dog. The rollers 400 extends generally along the axes 12a and 12b between first ends 402A rotatably supported by the first sidewall 110A (FIG. 1) and second ends 402B rotatably supported by the second sidewall 110B (also FIG. 1).

The rollers 400 configured in accordance with the present disclosure include magnetic and/or electrically conductive materials that generate heat when positioned in the magnetic field generated by the element 310 (FIG. 3A) or the elements 330 (FIG. 3B). Suitable magnetic and/or electrically conductive materials can include, for example, iron and iron alloys such as carbon steel. Other materials that can potentially be inductively heated include, for example, various grades of stainless steel, aluminum, brass, copper, nickel, titanium, etc. and other materials that are electrical conductors.

Magnetic fields have little or no effect on electrical insulators, such as glass, ceramics, polymers, etc. Accordingly, these materials can be suitable to use in portions of the food heater 10 where heating is undesirable. A magnetic shield (not shown), e.g., a highly electrically conductive material, can be used to mitigate the effects of a magnetic field on magnetic materials that are used in portions of the food heater 10 where heating is undesirable.

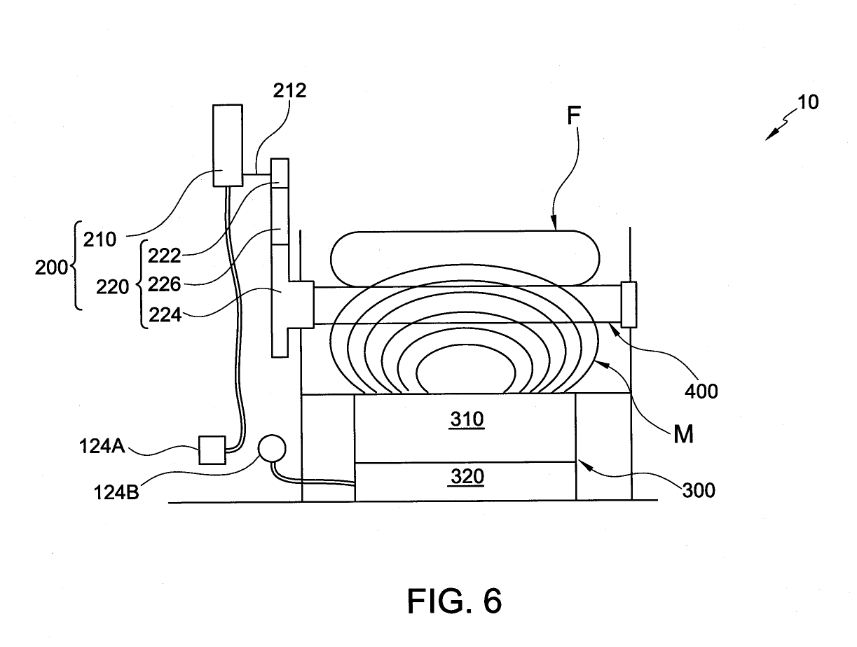

FIG. 6 is a schematic illustration of a system for cooking the food product F with the food heater 10 configured in accordance with an embodiment of the present disclosure. Initiating a cooking process using the food heater 10 can include operating the first control 124A (FIG. 1) to actuate the moving system 200, operating the second control 1248 (also FIG. 1) to actuate the heating system 300, and positioning the food product F on the rollers 400.

Actuating the moving system 200 includes energizing the actuator 210 (FIG. 2). Torque is transmitted via the output shaft 212 of the actuator 210 to the drive arrangement 220. Specifically, the torque is transmitted via the output shaft 212 to the drive sprocket 222, and transmitted via the drive chain 226 to the driven sprockets 224. Rotation of the driven sprockets 224 turns the corresponding rollers 400 coupled thereto. Embodiments in accordance with the present disclosure can turn the rollers 400 at a single speed, e.g., the first control 124A (FIG. 1) is an OFF/ON switch, turn the rollers at more than one speed, e.g., the first control 124A is an OFF/LOW/HIGH switch, or turn the rollers 400 at different speeds throughout a range of speeds, e.g., the first control 124A is infinitely adjustable between a minimum speed and a maximum speed.

Actuating the heating system 300 includes energizing the element 310 (FIG. 3A) or the element 330 (FIG. 3B). The magnetic field M generated by the element can be adjusted by the second control 124B (FIG. 1) to vary the signal supplied by the driver 320. For example, the voltage amplitude, current amplitude, and/or the current frequency can be varied to adjust the size and/or intensity of the magnetic field M. Other embodiments in accordance with the present disclosure can also include activating or deactivating individual electromagnets to selectively enlarge or reduce, respectively, the overall size of the magnetic field M.

The rollers 400 are at least partially positioned in the magnetic field M. The energy of the magnetic field M induces electrical currents in the magnetic material of the rollers 400, which generates heat in the rollers 400. The heat generated by the rollers 400 is conducted to the food product F while the rollers are turned by the drive system 200. Accordingly, the food product F can be inductively cooked and/or warmed while also being rotated by the rollers 400.

According to embodiments of the present disclosure, the rollers 400 are inductively heated via the magnetic field M that is generated by the element 310 (FIG. 3A) or the elements 330 (FIG. 3B). The heating can be limited to only the rollers 400. The base structure 100, the drive arrangement 220, and/or other components of the food heater 10 can be electrically shielded from the magnetic field M. Accordingly, undesirable heat transfer from the heating system 300 may be reduced or eliminated.

According to embodiments of the present disclosure, and rollers 400 can be inductively heated by a heating system 300 that is spaced from the rollers. Accordingly, there are no heating elements positioned within the rollers 400. Instead, remotely positioned electric coils that generate high-frequency electromagnetic fields M heat the rollers 400. Accordingly, the electric coils can be separated from the food product F that is being heated and can also be separated from the system 200 that is moving the food product F during heating. The base structure 100 can include barriers positioned between the movement system 200 and the food product F so as to be configured to prevent cross-contamination. Advantageously, the base structure 100, the movement system 200, and other features where heating is undesirable can be constructed with materials that are not heated by the electromagnetic field M and/or can be shielded from the electromagnetic field M.

According to embodiments of the present disclosure, food heating systems 10 can inductively cook hot dogs, sausage links, or other food products that can be cooked by rotation with heated rollers. Such inductive food heating systems 10 can be approximately 50% to more than 100% more energy efficient than conventional systems that use electric resistance heaters or fuel gas heaters.

According to embodiments of the present disclosure, methods of cooking hot dogs, sausage links, or other food products F by rotation with inductively heated rollers 400 can provide certain advantages with respect to, for example, cleaning and maintaining the food heating systems 10. For example, removable or fixed trays 126 can be easily cleaned, and separate movement and heating systems 200 and 300 can be easily serviced.

Aspects of the present application are generally directed toward apparatuses for applying heat to food. One aspect of certain embodiments includes a base, an induction coil supported by the base, a plurality of rollers spaced from the induction coil and configured to support the food, and a drive system operably coupled to the plurality of rollers and configured to rotate at least one of the rollers with respect to the base. The induction coil is configured to generate a magnetic field to inductively heat at least one of the rollers for heating the food.

Other aspects of certain embodiments include at least one induction-cooking element configured to generate a magnetic field, and at least one food support configured to rotate about an axis and apply heat to the food in response to being inductively heated by the magnetic field. The at least one food support being spaced from the at least one induction-cooking element.

Other aspects of the present application are generally directed toward methods for applying heat to food. One aspect of certain embodiments includes generating a magnetic field, inductively heating a plurality of rollers with the magnetic field, and driving individual rollers in rotation about corresponding individual axes. The plurality of rollers is configured to support, heat and turn the food.

Embodiments according to the present disclosure can include food heaters including inductively heated rollers.

Embodiments according to the present disclosure can include food heaters having electric coils that generate high-frequency electromagnetic fields and rollers composed of magnetic and/or electrically conductive materials.

Embodiments according to the present disclosure can include food heaters having roller heating systems spaced from roller rotating systems.

Embodiments according to the present disclosure can also include food heaters having a roller heating system that is spaced radially outward of a roller rotating system.

Embodiments according to the present disclosure can include food heaters having a roller heating system that applies little or no heat to a proximate roller rotating system.

Embodiments according to the present disclosure can include systems for cooking hot dogs, sausage links, or other food products that can be cooked by rotation with inductively heated rollers.

Embodiments according to the present disclosure can also include methods of inductively cooking hot dogs, sausage links, or other food products that can be cooked by rotation with heated rollers.

From the foregoing, it will be appreciated that specific embodiments of the invention have been described herein for purposes of illustration, but that various modifications may be made without deviating from the spirit and scope of the invention. Aspects of the invention described in the context of particular embodiments may be combined or eliminated in other embodiments. Furthermore, while advantages associated with certain embodiments of the invention have been described in the context of those embodiments, other embodiments may also exhibit such advantages, and not all embodiments need necessarily exhibit such advantages to fall within the scope of the invention.

I/We claim:

1. An apparatus for applying heat to food, comprising:
a base;
an induction coil supported by the base;
a plurality of rollers spaced from the induction coil and configured to support the food, wherein the induction coil is configured to generate a magnetic field to inductively heat at least one of the rollers for heating the food; and
a drive system operably coupled to at least one of the plurality of rollers and configured to rotate the at least one roller with respect to the base.

2. The apparatus according to claim 1 wherein individual rollers comprise electrical conductors configured to be disposed at least partially in the magnetic field.

3. The apparatus according to claim 1 wherein individual rollers rotate on corresponding individual axes, and the induction coil is spaced radially outward of the individual rollers.

4. The apparatus according to claim 1 wherein the base comprises an electrical insulator.

5. The apparatus according to claim 1, further comprising a plurality of induction coils, and each induction coil generates an individual magnetic field.

6. The apparatus according to claim 5 wherein individual induction coils correspond to respective individual rollers.

7. The apparatus according to claim 1, further comprising a driving circuit coupled to the induction coil.

8. The apparatus according to claim 1 wherein the drive system comprises:
individual sprockets coupled to respective individual rollers;
an electric motor fixed to the base; and
a drive chain coupling the electric motor to the individual sprockets and configured to rotate the individual rollers with respect to the base.

9. The apparatus according to claim 8, further comprising a magnetic shield disposed between the induction coil and the drive system.

10. The apparatus according to claim 1, further comprising a tray disposed between the induction coil and the plurality of rollers, wherein the tray comprises an electric insulator.

11. An apparatus for applying heat to food, comprising:
at least one induction-cooking element configured to generate a magnetic field; and
at least one food support configured to rotate about an axis and apply heat to the food in response to being inductively heated by the magnetic field, the at least one food support being spaced from the at least one induction-cooking element.

12. The apparatus according to claim 11, further comprising a moving system configured to turn the food on the at least one food support, the moving system rotating the at least one food support.

13. The apparatus according to claim 12 wherein the moving system is configured to avoid being inductively heated by the magnetic field.

14. The apparatus according to claim 11, further comprising a base supporting the at least one induction-cooking element and rotatably supporting the at least one food support, wherein the base is configured to avoid being inductively heated by the magnetic field.

15. A method for applying heat to food, comprising:
generating a magnetic field;
inductively heating a plurality of rollers with the magnetic field; and
driving individual rollers in rotation about corresponding individual axes;
wherein the plurality of rollers is configured to support, heat and turn the food.

16. The method according to claim 15, further comprising spacing the plurality of rollers from a source generating the magnetic field.

17. The method according to claim 15, further comprising varying the magnetic field to vary heating the plurality of rollers.

18. The method according to claim 15, further comprising generating a plurality of magnetic fields.

19. The method according to claim 18, further comprising varying an individual magnetic field to vary heating the plurality of rollers.

20. The method according to claim 18, further comprising varying an individual magnetic filed to vary heating a corresponding individual roller.
